(19) United States
(12) Patent Application Publication
(10) Pub. No.: US 2009/0066521 A1
(43) Pub. Date: Mar. 12, 2009

(54) Method and system for detecting the physiological onset of operator fatigue

(76) Inventors: Dan Atlas, Hod Hasharon (IL); Meir Ben David, Ra'anana (IL)

Correspondence Address: Dan Atlas;Meir Ben David, POB 271, Hod Hasharon, 45102, IL

(21) Appl. No.: 11/900,291

(22) Filed: Sep. 12, 2007

(51) Int. Cl. G08B 23/00

(52) U.S. Cl. 340/575

(57) ABSTRACT

A method and system for detecting the physiological onset of operator fatigue. The condition of the operator is correlated with physiological signs of the early stages in the process of falling asleep according to the Hori EEG model. Passive correlation is done via monitoring of the gripping pressure of the operator's hand(s) on a handgrip containing pressure transducers. Correlation with Hori stage 2 is a preliminary indicator of the onset of operator fatigue. Active correlation is done via contingent Psychomotor Vigilance Tests administered upon the preliminary indication, with operator stimulus from a vibratory element in the handgrip and operator response being a rapid increase in gripping pressure. Correlation of the frequency of contingent PVT requests with Hori stage 3 is a critical indicator of the onset of operator fatigue. Upon detection of the onset of fatigue, an alarm is signaled to the operator and other personnel.

### FIELD OF THE INVENTION

The present invention relates to a method and system for physiological monitoring, and, more particularly, to a method and system for anticipating and detecting the physiological onset of fatigue in a human operator.

### BACKGROUND OF THE INVENTION

One of the most significant sources of human error is fatigue in an operator. The term “operator” herein denotes any person (also denoted as a “subject”) assigned to perform a particular task which requires alertness and responsiveness to stimulus. Examples of operators include, but are not limited to: vehicle or craft operators and support personnel (e.g., drivers, pilots, helmsmen, engineers, navigators, traffic controllers); machinery or equipment operators; and personnel such as sentries, guards, signalmen, and watchmen. The term “fatigue” herein denotes any condition that impairs the suitability of an operator for the assigned task due to physiological factors induced by, or related to phenomena including, but not limited to: tiredness, weariness, or exhaustion; sleepiness, drowsiness, lack of sleep, insufficient sleep, or ineffective sleep; boredom, monotony, or apathy; diminished consciousness or altered consciousness; hypnotic effects, and the like; heat exhaustion or other environmental stress; and metabolic factors, such as hypoglycemia, substance-induced stupor such as intoxication, and the like.

Whatever human error can lead result in serious damage, injury, and death, fatigue in an operator is potentially catastrophic. There have therefore been many proposed solutions to the problem of alerting the operator and/or other personnel to the onset of fatigue.

### Onset of Fatigue and the Hazards Thereof

The term “onset of fatigue” herein denotes a physiological condition wherein the operator is beginning to experience early or preliminary effects of fatigue, but where the operator's abilities are only beginning to become impaired. According to the present invention, “onset of fatigue” is definable in terms of measurable physiological parameters, and encompasses the concept of the “sleep onset period” as denoted in certain prior art. During the onset of fatigue, the operator's alertness and responsiveness to stimulus is degraded, but the operator may still be able to successfully perform the assigned task, provided that the degraded alertness and responsiveness remain sufficient for the current needs. There are, however, two hazards associated with the onset of fatigue:
1. A critical event may occur, which demands a high degree of alertness and responsiveness to handle (e.g., an emergency situation, a mechanical failure, any sudden occurrence requiring rapid response). The operator in a non-fatigued condition might be able to handle the event, whereas the operator experiencing the onset of fatigue may not be able to handle it.
2. The onset of fatigue is generally a progressive condition, in which the operator's facilities continue to degrade. Often, the process culminates in the operator falling asleep and thereby becoming completely non-functional and unable to fulfill the assigned task to any degree.

Timely detection of the onset of fatigue thus allows anticipation of the progression of the condition prior to the occurrence of a critical event and/or the falling asleep of the operator. With early detection, it is possible to avoid catastrophic consequences of fatigue by assigning a new operator to the task, terminating the task, or taking steps to interrupt the progression of fatigue, in some cases reversing the process.

### Prior Art References

The extreme danger associated with undetected and unremedied fatigue has resulted in various attempts to automate detecting the onset of fatigue. Recent prior art in this field includes the related U.S. Pat. Nos. 5,917,415, 6,265,978, and 6,353,396 to Atlas, one of the present inventors (herein denoted as “Atlas '415”, “Atlas '978”, and “Atlas '396”, respectively), which disclose a wrist appliance to be worn by the subject for monitoring a variety of physiological factors such as EMG (Electromyographic activity), temperature, response to stimulation and muscular activity at the wrist, and detecting from these inputs the onset of fatigue.

Other recent prior art concentrates on the special case of a motor vehicle operator, and discloses sensors to enable monitoring the gripping pressure of the operator's hands on the vehicle steering wheel as an index of operator fatigue. Such prior art includes the following:
U.S. Pat. No. 5,585,785 to Gwin, et al. (herein denoted as “Gwin”), which discloses a pressure transducer on the circumference of a vehicle steering wheel for measuring the gripping pressure of the operator's hand on the wheel. A control unit establishes a lower threshold limit and sounds an alarm if a pressure transient indicates a substantial and sudden deterioration.
U.S. Pat. No. 5,969,616 to Tschoi (herein denoted as “Tschoi”), which discloses an aftermarket jacket for a vehicle steering wheel, containing pressure transducers for sensing gripping pressure of the operator's hands, similar to Gwin.

### Operator Handgrips and Gripping Pressure

The term “handgrip” herein denotes any device or object that is gripped by an operator during the course of carrying out the assigned task, the gripping being done by either or both hands. The term “grip” and variants thereof herein denote a deliberate, determined, and forceful grasping, clutching, or holding of a handgrip by the hand(s). According to the present invention, it is possible but not necessary that the handgrip control or govern any apparatus—passive objects that are gripped by the operator are also considered handgrips according to the present invention. Non-limiting examples of handgrips include: steering wheel; joy-stick; handlebar; tiller, helm, ship's wheel; control column, control-stick, control lever, or other lever; hand-rails and hand-holds; armrest; safety bar; and handle.

The term “gripping pressure” herein denotes any specific function related to the gripping force applied by the operator to a handgrip. Pressure is nominally measured in force per unit area. “Gripping pressure” as used herein can be expressed in force per unit area, and can also be expressed in terms and units including, but not limited to: average force per unit area, force, pressure integrated over an area, or any convenient function related to any of the foregoing as output from sensors. In particular, the various transducers employed to measure gripping pressure are generally responsive to a function of the force and the area over which the force is applied and generally have a measurable output corresponding to a function thereof, which may be a non-linear function. Accordingly, the term “gripping pressure” herein also denotes the measurement of operator gripping intensity expressed via the output of a sensor or transducer thereof, regardless of the specific physical parameters acting on the sensor or transducer.

### Threshold Measurements and Detection

Gwin and Tschoi are based on thresholds for detecting fatigue. Both Gwin and Tschoi disclose signaling an alert condition when the handgrip pressure falls below an established threshold.

It is noted that various thresholds can obviously be employed, such as a threshold for the absolute gripping pressure; a threshold for the time-average (or other statistical function) of the gripping pressure; a threshold for the spatial average (or other statistical function) of the gripping pressure; a threshold for a time-derivative of the gripping pressure; and so forth.

### Prior Art Limitations

The prior art on the subject of detecting the onset of fatigue in an operator falls into two categories: scientific investigations into the physiological phenomenon; and practical methods and systems for use in actual operator environments.

Scientific research has been conducted on measuring parameters of operator response and performance and correlating these with physiological phenomena of fatigue. These studies are accurate and definitive, but require complex instrumentation, such as EEG (Electroencephalogram), eye- and head-motion cameras, eyelid closure recording apparatus, and so forth. Systems of this sort are impractical to implement in actual operator environments, and none of these scientific methods has been successfully adapted for use to detect operator fatigue in practice.

Practical methods and systems for use in actual operator environments, however, generally are restricted to the use of simple sensors, such as gripping pressure transducers, and so forth. It is systems of this sort which are discussed as prior art herein. They are practical to implement in actual operator environments, but lack the accuracy of the more complex scientific systems.

Regarding Atlas '415, Atlas '978, and Atlas '396, which disclose a wrist appliance to be worn by the subject: although these references disclose monitoring a number of parameters that can provide a rich set of inputs to detect the onset of fatigue, the requirement to wear a wrist-mounted appliance places severe restrictions on the use of such apparatus and associated methods. This is clearly a limitation of all prior art that requires affixing sensors or other apparatus directly to the operator.

Regarding threshold-detecting systems, such as those of Gwin and Tschoi, the falling of the gripping pressure below a particular arbitrary threshold is not necessarily an accurate indication of the onset of fatigue. If the threshold is set too high, normal variations in the repositioning of the operator's hand(s) on the steering wheel, momentarily removing a hand from the steering wheel, etc., may result in false alarms. It can be appreciated that a system which issues an excessive number of false alarms will soon be considered a nuisance rather than a valuable safety appliance, and will cease being used. On the other hand, if the threshold is set too low, the system will fail to anticipate the onset of fatigue, and may signal an alert only when the driver has actually fallen asleep, by which time the alert is likely to be too late to be effective.

In other words, the prior art, as exemplified by Gwin and Tschoi, discloses the use of threshold points, but fails to teach means of precisely setting such a threshold or providing another means for detecting the physiological onset of fatigue in a timely manner, while also avoiding false alarms. Prior art thresholds therefore are arbitrary and are not based on demonstrated physiological principle. For example, although Gwin discloses the setting of a baseline normal gripping pressure according to each driver individually, except for being less than the baseline normal gripping pressure, the threshold for detecting the onset of fatigue is set arbitrarily, in a manner that has no objective correlation with physiological processes associated with the onset of fatigue. Prior art methods therefore detect conditions which are supposed to be indicative of the onset of fatigue, but which in reality are not necessarily related to any specific aspect of the phenomenon of falling asleep. As a result, prior art methods do not reliably and dependably detect the onset of fatigue, and either tend to trigger false alarms, or fail to detect the true physiological onset of fatigue.

There is thus a widely recognized need for, and it would be highly advantageous to have, a method and system for detecting the physiological onset of fatigue in an operator, which does not require the operator to wear an appliance, and which enables a precise determination of the actual physiological onset of fatigue according to scientific principles. This goal is met by the present invention.

### SUMMARY OF THE INVENTION

The goal of monitoring operators for fatigue is to anticipate impending catastrophic conditions due to fatigue as far in advance as possible of the actual occurrence of catastrophe. It is well-appreciated from ordinary experience that human fatigue is a condition which increases in intensity in a gradual fashion over a period of time.

Accordingly, a primary objective of the present invention is the detection of the onset of fatigue, i.e., the early stages of fatigue, thereby anticipating the later, more severe stages well in advance of the time that extreme danger is encountered.

An associated objective of the present invention is that the detection be done according to scientific physiological principles, but in a manner and with apparatus suitable for practical ongoing use in an actual user environment. In accordance with this objective, the present invention correlates measurable parameters of operator performance with the Hori stages indicative of fatigue, as presented in electroencephalogram (EEG) readings, as detailed herein.

Detecting indications of the onset of actual fatigue means that the risk of false alarm will be significantly reduced. Furthermore, an actual onset of the early stages of fatigue is a real event that accompanies a condition with potentially serious consequences; as such, the onset of fatigue deserves to be logged in some fashion, even if no adverse occurrences result from the onset.

It is also an objective of the present invention to provide a means for detecting the onset of fatigue in a passive manner that involves only quantitative observation of the operator via readings of gripping pressure on a handgrip.

It is a further objective of the present invention to provide another means for detecting the onset of fatigue in an interactive manner that involves sensory input to the operator via a handgrip.

It is yet another objective of the present invention to provide a means to interrupt or temporarily halt the process of fatigue.

Therefore, according to the present invention there is provided a method for detecting the physiological onset of fatigue in an operator, the physiological progression of operator fatigue being associated with a plurality of Hori stages having a specified sequence in time, the method including: (a) providing a handgrip for the operator to grip with at least one hand, wherein the handgrip is operative to produce a plurality of gripping pressure outputs, each of which is indicative of a gripping pressure of the operator; (b) providing a function correlating the plurality of gripping pressure outputs from the handgrip to the plurality of Hori stages; (c) designating a predetermined Hori stage corresponding to a point of physiological onset of fatigue in the operator; (d) obtaining a real-time gripping pressure output from the handgrip in response to operator gripping; (e) obtaining a current Hori stage corresponding to a real-time gripping pressure output according to the function; (f) if the current Hori stage is at least the predetermined Hori stage, then detecting the physiological onset of fatigue in the operator, and signaling an alarm in response thereto; and (g) if the current Hori stage is not at least the predetermined Hori stage, then continuing the obtaining a real-time gripping pressure output from the handgrip.

Also, according to the present invention there is provided a method for conducting a Psychomotor Vigilance Test of an operator, the method including: (a) providing a handgrip to be gripped by the operator with at least one hand, wherein the handgrip is operative to convey a vibratory tactile signal to the operator, and wherein the handgrip is operative to output a signal corresponding to the operator's gripping pressure in response to the operator gripping; (b) conveying a first vibratory signal from the handgrip to the operator, the first vibratory signal being a notification to the operator that a Psychomotor Vigilance Test is being conducted; (c) waiting a period of time; (d) conveying a second vibratory signal from the handgrip to the operator, the second vibratory signal being a stimulus to the operator; (e) detecting and measuring at least one of the following as response to the stimulus: an increase in gripping pressure; and a time delay from the stimulus to the increase in gripping pressure; and (f) comparing the response to the stimulus with a baseline to determine the onset of fatigue in the operator.

In addition, according to the present invention there is provided a method for detecting the physiological onset of fatigue in an operator, the physiological progression of operator fatigue being associated with a plurality of Hori stages having a specified sequence in time, the method including: (a) providing a Psychomotor Vigilance Test request rate timer operative to measure a Psychomotor Vigilance Test request rate of contingent Psychomotor Vigilance Test requests for the operator; (b) providing a function correlating the Psychomotor Vigilance Test request rate to the plurality of Hori stages; (c) designating a predetermined Hori stage corresponding to a point of physiological onset of fatigue in the operator; (d) repeatedly monitoring of the operator for a provisional indication of the onset of fatigue, and obtaining therefrom a Psychomotor Vigilance Test request rate; (e) obtaining a current Hori stage corresponding to the Psychomotor Vigilance Test request rate according to the function; (f) if the current Hori stage is at least the predetermined Hori stage, then detecting the physiological onset of fatigue in the operator and signaling an alarm in response thereto; and (g) if the current Hori stage is not at least the predetermined Hori stage, then continuing the repeatedly monitoring of the operator.

Moreover, according to the present invention there is provided a system for detecting the physiological onset of fatigue in an operator, the physiological progression of operator fatigue being associated with a plurality of Hori stages having a specified sequence in time, the system including: (a) a handgrip for gripping by at least one gripping hand of the operator, wherein the handgrip is operative to produce a plurality of gripping pressure outputs, each of which is indicative of a gripping pressure of the operator; (b) a gripping pressure function data unit relating the gripping pressure outputs to the plurality of Hori stages; (c) a predetermined identifier data unit for a Hori stage which is designated as indicating the physiological onset of fatigue in the operator; (d) a controller configured to be coupled to the handgrip, for receiving the gripping pressure outputs, for determining a current Hori stage corresponding to a gripping pressure output according to the gripping pressure function data unit, and for determining if the current Hori stage indicates the physiological onset of fatigue in the operator according to the predetermined identifier data unit for a Hori stage; and (e) an alarm connected to the controller, for signaling the physiological onset of fatigue in the operator if determined by the controller.

And furthermore, according to the present invention there is provided a controller device configured to receive an input of gripping pressure signals from a transducer corresponding to the gripping pressure of an operator, the controller including a gripping pressure comparison unit, wherein the gripping pressure comparison unit is operative to relate the gripping pressure signals to a set of Hori stages, and wherein the controller is operative to determining the occurrence of a predetermined Hori stage associated with the onset of fatigue, and wherein the controller is operative to signal the onset of fatigue in the operator upon determining the occurrence.

### BRIEF DESCRIPTION OF THE DRAWINGS

The invention is herein described, by way of example only, with reference to the accompanying drawings, wherein:

FIG. 1 illustrates typical electroencephalogram readings of the nine prior-art Hori stages of fatigue, inclusive of the waking state and the sleeping state.

FIG. 2A illustrates the physiological correlation of the prior art Hori stages with relative operator gripping pressure on a handgrip.

FIG. 2B illustrates the physiological correlation of the prior art Hori stages with typical relative frequency of requests for contingent Psychomotor Vigilance Testing.

FIG. 3 conceptually illustrates the instrumentation in a section of a handgrip according to an embodiment of the present invention.

FIG. 4 is a flowchart of a method for conducting a Psychomotor Vigilance Test according to an embodiment of the present invention.

FIG. 5 is a flowchart of a method of conducting a contingent Psychomotor Vigilance Test according to an embodiment of the present invention.

FIG. 6 is a conceptual block diagram of a system for detecting the onset of operator fatigue according to an embodiment of the present invention.

### DESCRIPTION OF THE PREFERRED EMBODIMENTS

The principles and operation of a system and method for detecting the onset of operator fatigue according to the present invention may be understood with reference to the drawings and the accompanying description.

For simplicity of illustration in certain descriptions and examples herein, the present invention is presented in terms of the non-limiting special case of detecting the onset of fatigue in a motor vehicle driver (the operator) as detected via sensors in the steering wheel (the handgrip), it being expressly understood that other cases and applications of the invention for use with other kinds of operators in other kinds of situations and circumstances, are not excluded thereby.

### Hori Stages

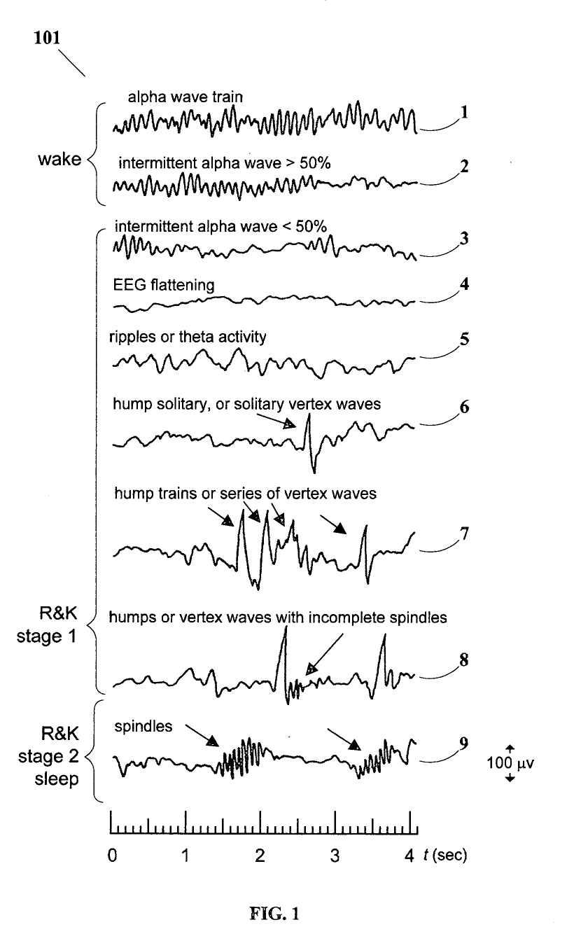

FIG. 1 illustrates typical electroencephalogram (EEG) readings of the nine prior-art “Hori” stages of fatigue 101 (Hori, Hayashi, and Morikawa, 1994), inclusive of a waking state in stage 1 followed sequentially by the other stages during the onset of sleep. The Hori stages are associated with the physiological progression of human fatigue, and have a specified sequence in time, progressing consecutively from stage 1 inclusive through stage 9 inclusive, in a complete, uninterrupted sequence as shown in FIG. 1. According to the present invention, it is possible to designate a particular predetermined Hori stage to correspond to the physiological onset of fatigue in an operator; if the current Hori stage of the operator is at least that predetermined Hori stage (i.e., the current Hori stage is the same as the predetermined Hori stage or a subsequent Hori stage in the specified sequence in time of the Hori stages), then according to the present invention it is determined that the physiological onset of fatigue in the operator has occurred.

The waking state generally features a mixture alpha wave and beta waves. Hori stage 1 represents a relaxed state of wakefulness, where alpha waves dominate. This initial stage is herein denoted as Hori stage 1. An initial stage of alert wakefulness typically combining alpha and beta waves (not shown) is used as a baseline.

A stage 2 features an intermittent alpha wave, wherein the alpha wave pattern is present more than 50% of the time. In the prior art “R&K” model (Rechtschaffen and Kales, 1968), states corresponding to Hori stages 1 through Hori stage 8 are grouped together as Stage 1 drowsiness. In the Hori model, however, stages 1 through 8 are considered highly distinct from one another. According to an embodiment of the present invention, a preliminary indicator of the onset of fatigue is physiologically identified with Hori stage 2. In this embodiment, therefore, Hori stage 2 is designated as a point of physiological onset of operator fatigue.

Continuing with the Hori model as illustrated in FIG. 1, a stage 3 features an intermittent alpha wave, wherein the alpha wave pattern is present less than 50% of the time. According to another embodiment of the present invention, a critical indicator of the onset of fatigue is physiologically identified with Hori stage 3. In this embodiment, therefore, Hori stage 3 is designated as another point of physiological onset of operator fatigue. According to an additional embodiment of the present invention, the preliminary indicator of the onset of fatigue can be used to trigger a request for interactive testing to determine whether the critical indicator of the onset of fatigue has been reached. This is discussed in detail below.

Further continuing with the Hori model as illustrated in FIG. 1, in a stage 4, the alpha wave is absent and the EEG is flattened. In a stage 5, a theta wave (“ripples”) appears, and in a stage 6, solitary vertex waves (“humps”) begin to appear. The vertex waves start appearing in sequences (“hump trains”) in a stage 7, and in a stage 8, short bursts referred to as “incomplete spindles” appear with the vertex waves (“humps”). Hori stages 3 through 8 are classified according to the previous R&K model as being in R&K stage 1 sleep.

Finally, in a Hori stage 9, complete spindles appear. Hori stage 9 is classified according to the previous R&K model as being in R&K stage 2 sleep.

### Determining Hori Stage via Gripping Pressure and Psychomotor Vigilance Testing

It has been noted that EEG monitoring is not practical in actual operator environments, and thus it is not feasible to directly determine the current Hori stage of the operator as would be done under special laboratory or clinical conditions. Therefore, according to embodiments of the present invention, the Hori stage is determined indirectly from two different, but interrelated parameters which are practical to measure in actual operator environments:
1. from the normalized gripping pressure exerted by the operator on a handgrip; and
2. from the frequency of contingent Psychomotor Vigilance Testing (“PVT”) requests initiated by a preliminary assessment of the onset of fatigue.

These are discussed in further detail below.

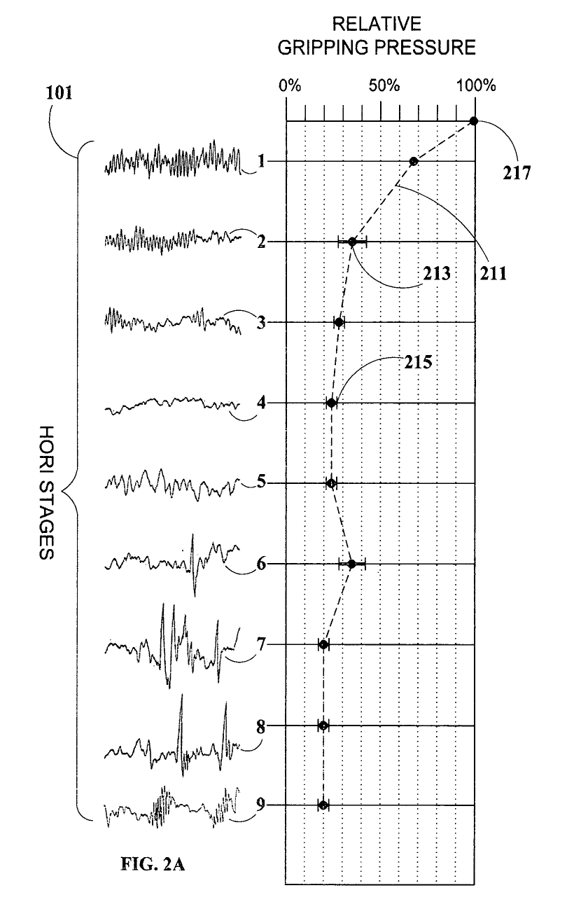

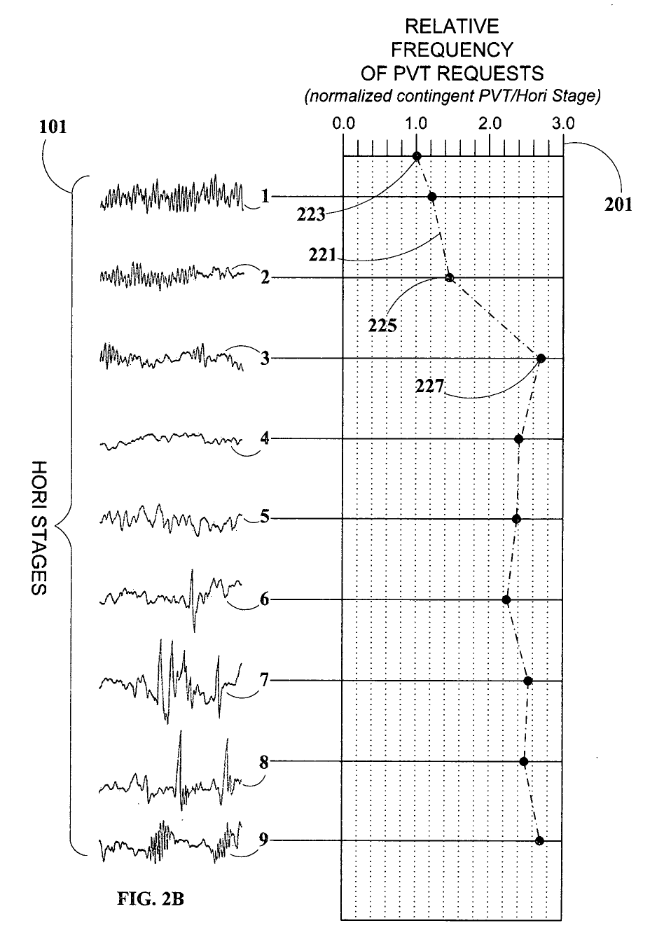

A novel and inventive aspect of the present invention is disclosed in FIG. 2A, which illustrates the physiological correlation between Hori stages 101 and operator gripping pressure relative to the restful waking state. A plot 211 shows the nominal linear percentage of gripping pressure during the various Hori stages 101 compared with a baseline 217 (100%) obtained when the operator is in the wakeful state. Plot 211 was derived by one of the present inventors through research which correlated hand gripping pressure to prior-art electromyographic (EMG) measurements of muscle tone during various Hori stages, including EMG data from the submentalis (chin) and forearm flexor muscles. Plot 211 thus serves as a function which correlates the gripping pressure output from a transducer in a handgrip which is gripped by an operator to the current Hori stage of the operator. It is once again emphasized that the correlation between electromyographic Hori stage data and hand gripping pressure as disclosed herein is an unexpected and thus non-obvious inventive step of the present invention.

A point 213 indicates the relative gripping pressure during Hori stage 2 (previously noted herein as a preliminary indicator of the onset of fatigue, according to an embodiment of the present invention).

It is further noted that Hori stage 4 marks the nominal low point in gripping pressure, shown as a point 215. Thereafter, gripping pressure does not fall significantly as the Hori stages continue to advance.

### Enabling and Disabling Fatigue Onset Detection

In many operator environments, there are occasions when the operator does not need to exercise a high degree of vigilance and may be expected to release his or her grip of the handgrip. A non-limiting example of such an occasion is when a vehicle driver (the operator) has completely stopped the vehicle and temporarily releases his or her hands from the steering wheel.

In such cases, monitoring the gripping pressure on the handgrip leads to erroneous results and false alarms. According to embodiments of the present invention, therefore, a means is provided for selectively enabling and disabling fatigue onset detection. During occasions when it is not appropriate to monitor the gripping pressure for indications of the onset of fatigue, the monitoring is disabled.

In an embodiment of the present invention wherein the handgrip is used to control a vehicle (as a steering wheel), additional factors such as the acceleration of the vehicle, and/or engine RPM, and/or transmission gear, etc., are sensed to provide disabling/enabling of fatigue onset monitoring.

### Handgrip Instrumentation

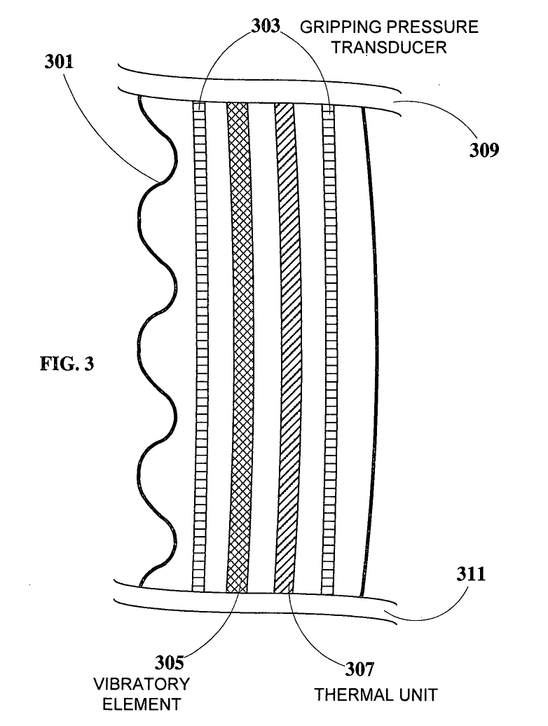

FIG. 3 conceptually illustrates the instrumentation of a section of a handgrip 301 according to an embodiment of the present invention. FIG. 3 conceptually portrays only a section between breaks 309 and 311—handgrip 301 has a physical extension depending on the precise nature and employment. As previously noted, handgrips according to the present invention include, but are not limited to: steering wheel; joy stick; handlebar; tiller; control lever or other lever; rails and hand-holds; armrest; safety bar; and handle. Further, according to the present invention, a handgrip may, but does not necessarily control or govern any apparatus. According to the present invention, the operator grips a handgrip with at least one hand.

According to embodiments of the present invention, handgrip 301 contains one or more gripping pressure transducers 303, non-limiting examples of which include: electrical devices such as force-sensitive resistors (FSR), strain gauges, and the like; and non-electrical devices utilizing pneumatic, hydraulic, and similar principles responsive to gripping pressure. In an embodiment of the present invention, transducers 303 are distributed over the outer surface of handgrip 301, whereas in another embodiment, transducers 303 are embedded within handgrip 301. The transducers create an output which is thus indicative of the operator's gripping pressure on the handgrip.

In a further embodiment of the present invention, transducers 303 are distributed geometrically in such a manner that they are responsive to gripping pressure from all directions (i.e., “omni-directional sensors”). In yet another embodiment, transducers 303 are distributed in portions of handgrip 301 which are not necessarily intended as primary gripping surfaces, but which may be gripped by the operator. As a non-limiting example of such distribution, in an embodiment of the present invention, transducers 303 are distributed along the surfaces of the spokes and rim of a steering wheel.

FSR transducers are utilized in a preferred embodiment of the present invention because of low cost, simplicity, reliability, and ease of output processing.

A vibratory element 305 is included in the handgrip according to another embodiment of the present invention. Vibratory element 305, when activated, creates vibratory tactile sensations in the gripping hand(s) of the operator. According to certain embodiments of the present invention, vibratory element 305 is used to convey a vibratory tactile signal or alarm to the operator, and according to certain other embodiments of the present invention, vibratory element 305 is used as sensory stimulus to perform Psychomotor Vigilance Testing, as detailed below.

According to the present invention, the operator grips the handgrip using at least one hand, substantially at all times during the period when the operator is monitored for fatigue. The handgrip thereby provides a real-time output signal corresponding to the operator's gripping pressure in response to operator gripping, for analysis and detection of the physiological onset of fatigue. In an embodiment of the present invention, the increase of gripping pressure in response to the stimulus is analyzed and compared with the baseline readings to detect the onset of fatigue in the operator. In a related embodiment the time delay from the time of stimulus to the time of increased gripping pressure is analyzed and compared with the baseline readings to detect the onset of fatigue in the operator.

### Passively Detecting the Onset of Operator Fatigue

As noted above, according to an embodiment of the present invention, a preliminary indicator of the onset of fatigue is a fall of the gripping pressure corresponding to Hori stage 2.

In the above embodiments of the present invention, the detection is done passively without providing input to the operator. In a related embodiment, an alarm (e.g., an audible alarm) is given upon a preliminary indication of the onset of fatigue, to alert the operator and/or other personnel to the condition.

### Baseline Calibration

According to an embodiment of the present invention, a baseline calibration of the gripping pressure transducers is conducted when the operator first grips the handgrip. According to this embodiment, during baseline calibration it is presumed that the operator is in a state of wakefulness. Thereafter, outputs from the gripping pressure transducers are normalized to the baseline calibration reading. In an embodiment of the present invention, the real-time gripping pressure output is expressed as a percentage of the baseline calibration output. It is assumed herein that the transducer output is conditioned as necessary (such as by the appropriate circuitry) so that an increase in gripping pressure results in an increase of the transducer output.

### Distinguishing Between the Onset of Fatigue and Crisis Conditions

It is noted that gripping pressure diminishes in a gradual fashion on account of fatigue, in contrast to the sudden and abrupt total loss of gripping pressure that typically occurs during crisis conditions, such as through instantaneous incapacitation of the operator due to acute distress or emergency. In an embodiment of the present invention, sudden and abrupt total loss of gripping pressure is detected and signaled to other personnel as an emergency condition.

### Psychomotor Vigilance Testing

A Psychomotor Vigilance Test (“PVT”) generally involves giving the subject a stimulus of some sort, and then gauging the quality of the response in terms of parameters such as reaction time, reaction intensity, and so forth.

In an embodiment of the present invention, a “contingent PVT” is administered to the operator in response to a preliminary determination of the onset of fatigue, and the results are analyzed to obtain a more definitive determination regarding the onset of fatigue. In another embodiment of the present invention, a series of “non-contingent PVT's” is administered to the operator according to a predetermined schedule without requiring a determination of the onset of fatigue (e.g., a non-contingent PVT every 10 minutes).

In the above embodiments of the present invention featuring PVT's, the detection is done actively, providing input to the operator as part of the PVT. This interaction with the operator also provides an intervention in the process of fatigue which can, to some degree, interfere with the sequence of falling asleep.

### Handgrip PVT

Prior-art PVT subject stimulus is typically in audible or visual form, such as a buzzer or light. In a novel embodiment of the present invention, however, the operator stimulus is tactile, wherein handgrip 301 is provided with vibratory element 305 (FIG. 3) to produce the operator stimulus.

### Handgrip Temperature Stabilization

According to an embodiment of the present invention, handgrip 301 is provided with a thermal unit 307 (FIG. 3), which senses the local temperature of handgrip 301 and stabilizes the temperature by heating or cooling as appropriate, to maintain temperature in a desired range.

The inclusion of thermal unit 307 in handgrip 301 serves two purposes. First, if the handgrip temperature deviates significantly from a comfortable range, the operator might not use a proper or consistent grip, thereby impacting the accuracy of the system in detecting the onset of fatigue. Second, temperature extremes (such as are often encountered in an automobile) might adversely affect the output of gripping pressure transducers 303 and thereby lead to erroneous or distorted readings, particularly during the initial baseline. Temperature stabilization by thermal unit 307 reduces these effects.

Thermal unit 307 can be implemented in various ways known in the art, such as by a Peltier effect heat pump or other thermoelectric devices to sense and control temperature.

### PVT Method

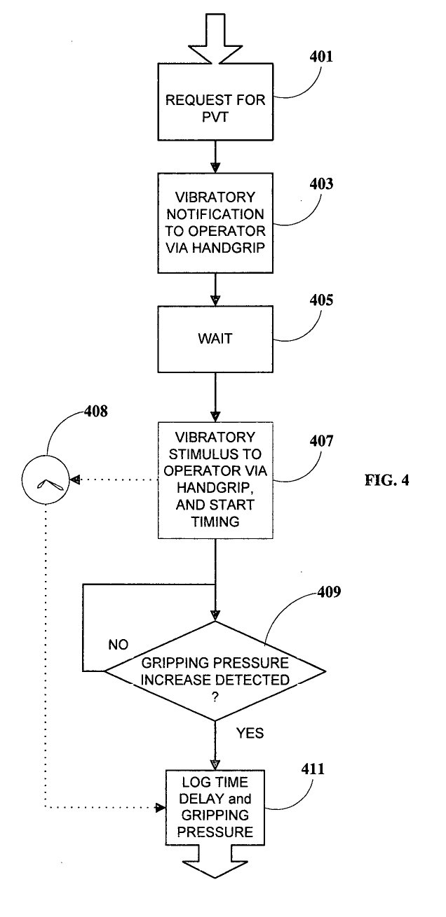

As noted previously, certain embodiments of the present invention provide for Psychomotor Vigilance Testing (“PVT”). A method for conducting a PVT according to a preferred embodiment of the present invention is illustrated in the flowchart of FIG. 4. Starting with a request for PVT 401, the operator is alerted to the administrating of a PVT by a first vibratory notification 403, which is signaled via vibratory element 305 of handgrip 301 (FIG. 3). As a non-limiting example, a short series of pulsed vibrations in the handgrip can be used as a pre-arranged signal to the operator that a PVT is going to be administered soon. The operator is previously instructed that such a series of vibrations is merely an indication of an impending PVT, and no response to the notification is to be given by the operator.

When the operator feels the vibratory notification, he or she is thereby alerted to the upcoming PVT. Then, in a wait step 405, an amount of time is waited, typically of the order of a second to several seconds. In a preferred embodiment of the present invention, the wait time is varied randomly, so that the operator cannot anticipate precisely when the PVT will take place. In a related preferred embodiment of the present invention, the wait time is randomly selected to be between a predetermined lower limit and a predetermined upper limit.

After the wait time has transpired, in a step 407 a second vibratory stimulus is sent to the operator via vibratory element 305 of handgrip 301 (FIG. 3), and timing is commenced, using a stopwatch 408. The term “stopwatch” herein denotes a timer which can be reset to zero, started, stopped, and which displays, reports, and/or records the time interval between being started and being stopped. As a non-limiting example, a long steady vibration can be used as a pre-arranged stimulus to the operator, indicating the beginning of the PVT. The operator is previously instructed that when the vibratory stimulus is felt, to immediately grip the handgrip as strongly as possible. In a decision point 409, the operator's response to the vibratory stimulus is detected. As soon as an increase in gripping strength is detected by corresponding change in the output from the gripping pressure transducer 303 (FIG. 3), in a logging step 411, the response time interval (the time delay between the stimulus and the response, as recorded by stopwatch 408), is logged for analysis or other purposes. In a preferred embodiment of the present invention, logging step 411 also logs a predetermined function of the gripping pressure exerted by the operator in response to the PVT. Non-limiting examples of such functions include: average gripping pressure, maximum gripping pressure, time duration of the increased gripping pressure, and so forth. Logging step 411 also provides output of the logged PVT response for analysis.

In a preferred embodiment of the present invention, a stopwatch is employed in the initial baseline calibration of response times for later comparisons. In an alert operator, typical response times are less than one second, whereas after the onset of fatigue, typical response times exceed one second.

### PVT Intervention

The present inventors have noted that the administrating of a PVT in the manner described above shortly after a preliminary indication of the onset of fatigue has a capacity to intervene in the progress of the fatigue, temporarily delaying the onset of fatigue for periods up to 90 minutes in certain cases.

Therefore, providing a PVT capability according to embodiments of the present invention serves several functions: first, requests for contingent PVTs provide additional data to gauge the operator's current Hori stage (as detailed below). Second, the PVT results can provide additional data to gauge the onset of fatigue. Third, the PVT can forestall, to some extent, the onset of operator fatigue and thus can, in some cases, boost operator alertness and act to delay the onset of a critical fatigue condition.

### Contingent PVT for Detecting the Onset of Operator Fatigue

As defined above, a request for a contingent PVT is in response to a condition. In an embodiment of the present invention, the detecting of a preliminary indication of the onset of fatigue is such a condition, the response to which is to request administering a PVT as detailed previously.

In another embodiment of the present invention, the operator is monitored for a provisional indication of the onset of fatigue. Subsequently detecting a provisional indication is such a condition for a request to administer a PVT. In this embodiment, a provisional indication of the onset of fatigue need not be correlated with physiological factors, such as the Hori stages; the term “provisional indication of the onset of fatigue” herein denotes any sign that is considered to be characteristic or demonstrative of operator fatigue, including, but not limited to test results and evaluations. In a related embodiment of the present invention, operator requests for a PVT in response to feelings of drowsiness are provisional indications of the onset of fatigue. In another related embodiment, a provisional indication of the onset of fatigue is an indication of the physiological onset of fatigue as presented above. In still another related embodiment, a provisional indication of the onset of fatigue is a preliminary indication of the physiological onset of fatigue as presented above.

FIG. 2B illustrates the physiological correlation between Hori stages 101 and relative frequency of contingent PVT requests. A plot 221 shows a nominal and typical number of contingent PVTs requested per Hori stage. Plot 221 thus serves as a function which correlates the relative rate of contingent PVT requests per Hori stage of the operator. A scale 201 is shown ranging from 0.0 to 3.0 in a non-limiting example; by varying a sensitivity parameter, PVTs can be administered to occur proportionately more or less frequently as desired. According to an embodiment of the present invention, adjustment of this sensitivity is not a baseline calibration, but is an adjustment of the typical readings indicated by FIG. 2B, which can be used as shown without initialization or calibration. Thus, the term “rate of PVT request” herein denotes a function that correlates any measurement of time or rate of PVT request for an operator to the operator's Hori stage. In connection with this, the term “PVT request rate timer” herein denotes any timer or similar functionality that measures time intervals between consecutive PVT requests and/or the rate of PVT requests.

A point 223 corresponds to the relative number of contingent PVTs requested to be administered when the operator is in the wakeful state, such that the contingent PVTs that are requested are attributed to inattention rather than fatigue. Point 223 thus establishes a baseline, normalized to 1.0. It is noted that inattention may be, but is not necessarily, a consequence of fatigue. A point 225 corresponds to the relative number of contingent PVTs requested when the operator is in Hori stage 2.

A point 227 corresponds to the relative number of contingent PVTs requested when the operator is in Hori stage 3. It is noted that this is typically the maximum number of contingent PVTs that are requested. At more advanced Hori stages, the number of PVTs requested does not significantly increase, and typically even decreases slightly.

Thus, when the number of contingent PVTs requested increases to a relative level as indicated by point 227, according to an embodiment of the present invention, this condition is a critical indicator of the onset of fatigue.

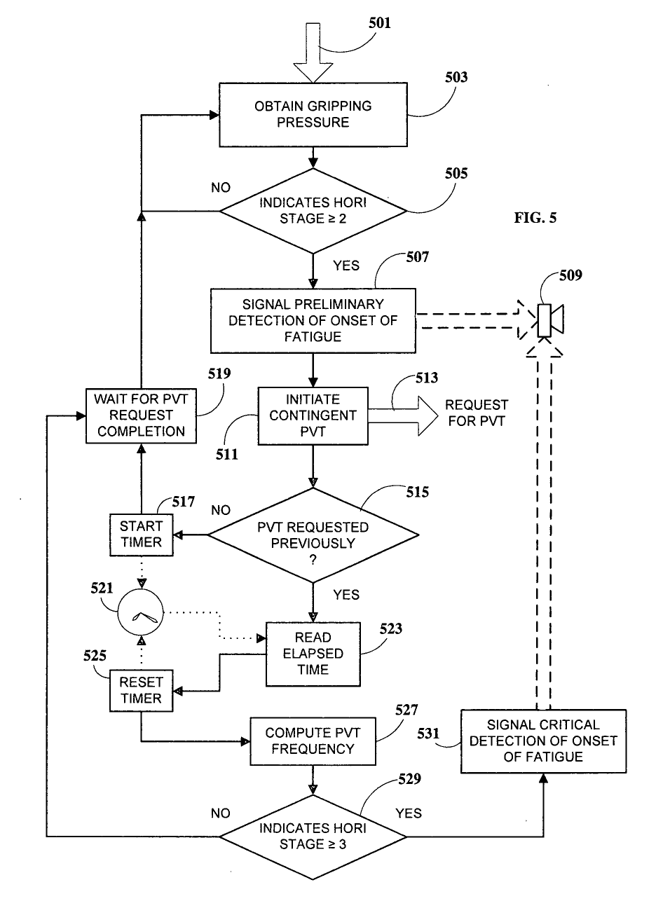

FIG. 5 is a flowchart of a method of conducting contingent Psychomotor Vigilance Testing according to an embodiment of the present invention. After a starting point 501, the gripping pressure is obtained in a step 503. A decision point 505 determines whether the gripping pressure corresponds to Hori stage 2 or greater, according to the baseline calibration and passive detection of the onset of fatigue with reference to plot 211 (FIG. 2A), as previously discussed. If the gripping pressure does not correspond to Hori stage 2 or greater, step 503 is repeated. If, however, the gripping pressure corresponds to Hori stage 2 or greater, then in a step 507, a preliminary detection of the onset of fatigue is signaled, via an alarm device 509. Non-limiting examples of alarm device 509 include: audible alarm; visual alarm; tactile alarm, such as a vibratory signal; message notification, remote or wireless alarm notification; event recording and/or logging; and combinations of the foregoing.

It is noted above that inattention can contribute to a relaxation of the operator grip, and therefore can result in an erroneous preliminary determination of the onset of fatigue. According to this embodiment of the present invention, therefore, active detection means involving contingent PVT is used to obtain a confirmation of the onset of fatigue. This is illustrated in FIG. 5 by a step 511 which requests a contingent PVT via a request for PVT 513.

After request for PVT 513 is sent, a decision point 515 determines whether a contingent PVT was previously requested as part of this series. If a PVT was not previously requested, a PVT request rate timer 521 is started running in a step 517. After starting PVT request rate timer 521, PVT request 513 is allowed to complete in a wait step 519, after which step 503 is repeated.

If decision point 515 indicates that a PVT was previously requested, the elapsed time is read from PVT request rate timer 521 in a step 523, and in a step 525 PVT request rate timer 521 is reset. In a step 527, the PVT frequency is computed, and then a decision point 529 determines whether Hori stage 3 or greater is indicated, according to plot 221 (FIG. 2B). If Hori stage 3 or greater is not indicated, then wait step 519 is executed, after which the method continues with step 503. If, however, Hori stage 3 or greater is indicated, then in a step 531, a critical detection of the onset of fatigue is signaled via alarm device 509.

### Non-Contingent PVT

According to another embodiment of the present invention, non-contingent PVTs are administered at intervals specified by a predetermined schedule. In a non-limiting mode, the non-contingent PVT interval is pre-assigned according to environmental demands for the operator; in another non-limiting mode, it is the operator who requests a specific PVT administration interval according to his or her personal preferences; in yet another non-limiting mode, the operator can request a PVT on demand, such as when he or she feels drowsy. According to another embodiment of the present invention, the frequency of such operator PVT demands, and/or the operator-requested PVT interval is correlated with Hori stage, as illustrated in FIG. 2B.

### System for Detecting the Onset of Operator Fatigue

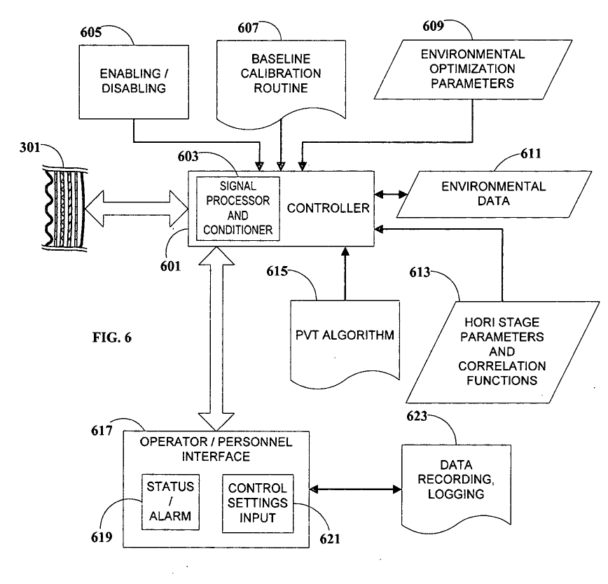

FIG. 6 is a conceptual block diagram of a system for detecting the onset of operator fatigue according to an embodiment of the present invention. The system includes a controller 601, which typically is a processor or microprocessor. Controller 601 includes a signal processor and conditioner 603, which receives and processes the transducer readings from handgrip 301 (also see FIG. 3). Signal processor and conditioner, in a non-limiting example, averages signals to reduce the effect of spurious transients. As a non-limiting example, transducer readings can be time-averaged or filtered to reduce the effects of transient and momentary changes in gripping pressure, such as when the operator repositions his or her hand(s) on the handgrip. Signal processor and conditioner 603 is shown as part of controller 601, but in another embodiment of the present invention is implemented as a separate device.

As previously discussed, it is necessary to selectively enable and disable the detection of the onset of fatigue, to avoid excessive false alarms during periods when the operator cannot be properly monitored (e.g., when a motor vehicle is stopped). According to an embodiment of the present invention, therefore, an enabling/disabling unit 605 provides input to controller 601 to implement this feature. Non-limiting responses for enabling/disabling unit 605 include: manual selection of enabling/disabling by the operator or other personnel; automatic enabling/disabling according to operational parameters such as detected motion, acceleration, power delivery or consumption, equipment operation, vibration, engine RPM, etc.

A baseline calibration routine 607 provides baseline calibration for startup, as previously described. Environmental optimization parameters in a storage area 609 provide the system with input needed to make certain adjustments. As a non-limiting example, environmental optimization parameters in storage area 609 can signal controller 601 to activate thermal unit 307 (FIG. 3) to adjust the handgrip temperature.

A set of environmental data in a data unit 611 provides flexibility under changing environmental conditions. As further detailed below, this can be supplemented by a data recording and logging unit 623. As a non-limiting example of such flexibility: time-of-day, duration of the operating session, temperature, and other factors can be taken into consideration to modify or adjust the determination criteria accordingly, and to provide confirmation with determinations based on Hori stage correlation. In this non-limiting example, late-night operation for an operator who has been on duty for an excessive length of time (as recorded in data recording and logging unit 623) can be taken into consideration to confirm a critical detection of the onset of fatigue according to Hori stage. Environmental data unit 611, includes, but is not limited to: time-of-day; elapsed time, time interval measurements, and rate measurements (such as stopwatch 408 and PVT request rate timer 521); and temperature and the like.

Hori stage parameters and correlation functions in a data unit 613 include data as well as pattern-matching algorithms which provide the system with the ability to correlate measurable quantities with the current Hori stage, as discussed previously and as indicated in plot 211 (FIG. 2A) and plot 221 (FIG. 2B). In an embodiment of the present invention, Hori stage parameters and correlation functions in data unit 613 also include a data unit containing a predetermined data identifier for a Hori stage which is designated as indicating the physiological onset of fatigue in the operator.

In an embodiment of the present invention, the operator determines, adjusts, or influences the sensitivity of the system (e.g., 5 levels), using the steering wheel sensors for the input, to increase or decrease the number of PVT tests.

PVT algorithm 615 encapsulates the method as previously detailed to perform a PVT according to embodiments of the present invention, to be executed by controller 601. For example, step 407 (FIG. 4) includes providing a vibratory stimulus to the operator via handgrip 301 and the start of stopwatch 408. In the present embodiment, these functions are performed by controller 601 via sending a vibratory signal to vibratory element 305 (FIG. 3) of handgrip 301, and starting a stopwatch or PVT rate timer, such as a timer in environmental data unit 611.

Operator/Personnel interface 617 provides control input 621 and status/alarm output 619 from controller 601. Personnel and/or operator can, for example set up non-contingent PVTs, as previously discussed. Alarm device 509 (FIG. 5) can be implemented via status/alarm output 619.

Data recording and logging unit 623 includes, but is not limited to: data records pertinent to current operator performance; statistical operator patterns; comparison of the current operator to other operators and to statistical norms. This data is available for external analysis as well as for immediate feedback by controller 601, as noted previously.

Yet another embodiment of the present invention provides a controller device (such as controller 601) that receives an input of gripping pressure signals from an external transducer, and is configured to determine a current Hori stage corresponding to the gripping pressure signals, according to a gripping pressure comparison unit relating the gripping pressure signals to the Hori stages. According to this embodiment, the controller is capable of determining the occurrence of a predetermined Hori stage associated with the onset of fatigue, and thereby signaling the onset of fatigue of an operator whose gripping pressure signals are input to the controller, and for signaling the onset of fatigue.

While the invention has been described with respect to a limited number of embodiments, it will be appreciated that many variations, modifications and other applications of the invention may be made.

1. A method for detecting the physiological onset of fatigue in an operator, the physiological progression of operator fatigue being associated with a plurality of Hori stages having a specified sequence in time, the method comprising:
providing a handgrip for the operator to grip with at least one hand, wherein said handgrip is operative to produce a plurality of gripping pressure outputs, each of which is indicative of a gripping pressure of the operator;
providing a function correlating said plurality of gripping pressure outputs from said handgrip to the plurality of Hori stages;
designating a predetermined Hori stage corresponding to a point of physiological onset of fatigue in the operator;
obtaining a real-time gripping pressure output from said handgrip in response to operator gripping;
obtaining a current Hori stage corresponding to a real-time gripping pressure output according to said function;
if said current Hori stage is at least said predetermined Hori stage, then detecting the physiological onset of fatigue in the operator, and signaling an alarm in response thereto; and
if said current Hori stage is not at least said predetermined Hori stage, then continuing said obtaining a real-time gripping pressure output from said handgrip.

2. The method of claim 1, further comprising:
conducting a baseline calibration of real-time gripping pressure output.

3. The method of claim 1, wherein said predetermined Hori stage is Hori stage 2.

4. A method for conducting a Psychomotor Vigilance Test of an operator, the method comprising:
providing a handgrip to be gripped by the operator with at least one hand, wherein said handgrip is operative to convey a vibratory tactile signal to the operator, and wherein said handgrip is operative to output a signal corresponding to the operator's gripping pressure in response to the operator gripping;
conveying a first vibratory signal from said handgrip to the operator, said first vibratory signal being a notification to the operator that a Psychomotor Vigilance Test is being conducted;
waiting a period of time;
conveying a second vibratory signal from said handgrip to the operator, said second vibratory signal being a stimulus to the operator;
detecting and measuring at least one of the following as response to said stimulus:
an increase in gripping pressure; and
a time delay from said stimulus to said increase in gripping pressure; and
comparing said response to said stimulus with a baseline to determine the onset of fatigue in the operator.

5. The method of claim 4, wherein said period of time is randomly determined.

6. The method of claim 4, wherein said handgrip is further operative to create a gripping pressure output indicative of a gripping pressure of the operator; the method further comprising:
providing a response stopwatch operative to measure an operator response time interval;
after said waiting a period of time, starting said response stopwatch;
monitoring said gripping pressure output;
when said gripping pressure output increases in response to said operator increase of said gripping pressure, obtaining from said response stopwatch an operator response time interval for the Psychomotor Vigilance Test.

7. A method for detecting the physiological onset of fatigue in an operator, the physiological progression of operator fatigue being associated with a plurality of Hori stages having a specified sequence in time, the method comprising:
providing a Psychomotor Vigilance Test request rate timer operative to measure a Psychomotor Vigilance Test request rate of contingent Psychomotor Vigilance Test requests for the operator;
providing a function correlating said Psychomotor Vigilance Test request rate to the plurality of Hori stages;
designating a predetermined Hori stage corresponding to a point of physiological onset of fatigue in the operator;
repeatedly monitoring of the operator for a provisional indication of the onset of fatigue, and obtaining therefrom a Psychomotor Vigilance Test request rate;
obtaining a current Hori stage corresponding to said Psychomotor Vigilance Test request rate according to said function;
if said current Hori stage is at least said predetermined Hori stage, then detecting the physiological onset of fatigue in the operator and signaling an alarm in response thereto; and
if said current Hori stage is not at least said predetermined Hori stage, then continuing said repeatedly monitoring of the operator.

8. The method of claim 7, further comprising:
upon receiving a provisional indication of the onset of fatigue in the operator, administering a contingent Psychomotor Vigilance Test.

9. The method of claim 7, wherein said predetermined Hori stage is Hori stage 3.

10. The method of claim 7, wherein at least one of said first provisional indication of the onset of fatigue and said second provisional indication of the onset of fatigue is an indication of the physiological onset of fatigue.

11. A system for detecting the physiological onset of fatigue in an operator, the physiological progression of operator fatigue being associated with a plurality of Hori stages having a specified sequence in time, the system comprising:
a handgrip for gripping by at least one gripping hand of the operator, wherein said handgrip is operative to produce a plurality of gripping pressure outputs, each of which is indicative of a gripping pressure of the operator;
a gripping pressure function data unit relating said gripping pressure outputs to the plurality of Hori stages;
a predetermined identifier data unit for a Hori stage which is designated as indicating the physiological onset of fatigue in the operator;
a controller configured to be coupled to said handgrip, for receiving said gripping pressure outputs, for determining a current Hori stage corresponding to a gripping pressure output according to said gripping pressure function data unit, and for determining if said current Hori stage indicates the physiological onset of fatigue in the operator according to said predetermined identifier data unit for a Hori stage; and
an alarm connected to said controller, for signaling the physiological onset of fatigue in the operator if determined by said controller.

12. The system of claim 11, wherein said handgrip is further operative to creating vibratory tactile sensations in said at least one gripping hand, wherein said controller is operative to activate said handgrip to produce said vibratory tactile sensations, and wherein said controller is operative to receive a plurality of requests to administer a contingent Psychomotor Vigilance Test, the system further comprising:
a Psychomotor Vigilance Test request rate timer, for determining a Psychomotor Vigilance Test request rate from a plurality of requests to administer a contingent Psychomotor Vigilance Test; and
a Psychomotor Vigilance Test request function relating said Psychomotor Vigilance Test request rate to the plurality of Hori stages.

13. The system of claim 12, further comprising:
a Psychomotor Vigilance Testing algorithm for administering a Psychomotor Vigilance Test to the operator.

14. The system of claim 12, wherein a provisional indication of the onset of fatigue in the operator is a request to administer a contingent Psychomotor Vigilance Test.

15. The system of claim 12, wherein a determination that said current Hori stage indicates the physiological onset of fatigue in the operator is a request to administer a contingent Psychomotor Vigilance Test.

16. The system of claim 11, further comprising:
an enabling/disabling unit for selectively enabling said controller to detect the physiological onset of fatigue in the operator.

17. The system of claim 11, further comprising:
a thermal unit for stabilizing handgrip temperature.

18. A controller device configured to receive an input of gripping pressure signals from a transducer corresponding to the gripping pressure of an operator, the controller comprising a gripping pressure comparison unit, wherein said gripping pressure comparison unit is operative to relate the gripping pressure signals to a set of Hori stages, and wherein the controller is operative to determining the occurrence of a predetermined Hori stage associated with the onset of fatigue, and wherein the controller is operative to signal the onset of fatigue in the operator upon determining said occurrence.
